(19) United States
(12) Patent Application Publication
(10) Pub. No.: US 2021/0387210 A1
(43) Pub. Date: Dec. 16, 2021

(54) ROTARY JET NOZZLE ASSEMBLY FOR PRESSURE CLEANING DEVICES

(71) Applicant: P.A. S.P.A., Rubiero (RE) (IT)

(72) Inventor: Arnaldo Benetti, Modena (IT)

(73) Assignee: P.A. S.P.A., Rubiera (RE) (IT)

(21) Appl. No.: 17/291,124

(22) PCT Filed: Nov. 4, 2019
(86) PCT No.: PCT/EP2019/080128

§ 371 Date: May 4, 2021

(30) Foreign Application Priority Data
Nov. 5, 2018 (EP) 18425083.5

(51) Int. Cl. B05B 3/04; B08B 3/02

(52) U.S. Cl. CPC B05B 3/0463; B08B 3/02

(57) ABSTRACT

Rotary jet nozzle assembly (1) for pressure cleaning devices, comprising: a housing (2) extended along a first longitudinal axis (X) between an inlet (3) and an outlet (4) of a washing liquid, defining therein a containment chamber (5) of the washing liquid in fluid communication with the inlet (3); a support (10) rotatable within said containment chamber (5) and about the first longitudinal axis (X) due to the effect of the washing liquid coming from the inlet (3); a nozzle body (20) extended along a second longitudinal axis (Y) inclined with respect to the first longitudinal axis (X) and traversed by a delivery duct (28), the nozzle body (20) being associated with the support (10) and driven in rotation thereby; and a counterweight, integral with the support (10) and arranged in a position that is eccentric and opposite the nozzle body (20) with respect to the first longitudinal axis (X).

### FIELD OF APPLICATION

The present invention relates to a nozzle assembly for generating a rotary jet, in particular in the context of pressure washing applications.

Therefore, the invention finds useful application in the technology field of pressure cleaning devices, preferably high pressure cleaning devices, such as for instance high pressure washer machines.

The following description is made with non-limiting reference to the use in the context of said field.

### PRIOR ART

In the field identified in the previous paragraph, nozzle assemblies are used to deliver washing liquid under pressure coming from a washing device such as for instance a pressure washer machine.

In the specific case of pressure washers, the nozzle assembly is arranged at the end of a lance which can be gripped by the user to direct and adjust the washing liquid delivery.

Rotary jet nozzle assemblies, which allow delivering a conical washing liquid jet so as to hit a larger surface to be washed with respect to the single fixed jet, are particularly used.

The rotary jet nozzle assemblies known nowadays use a nozzle body which is movable within a containment chamber; said movable body has a delivery head which is constrained to a front seat of said chamber by slidingly lying thereon, chamber where the delivery mouth of the device opens, and an inclined longitudinal stem driven in rotation within the chamber itself.

If in the past relatively complex mechanical systems were used to drive in rotation the stem of the nozzle body, in high pressure applications (25-1000 bar) solutions in which the stem is driven by the washing liquid itself entering the chamber are nowadays mostly used.

The prior art devices, though substantially meeting their purpose, however, have some drawbacks which have not been solved up to date.

First of all, it is noticed how the nozzle assemblies used nowadays are subjected, in use, to mechanical oscillations having relatively high amplitude and frequency, especially at high working pressures. These oscillations translate into vibrations of considerable entity that are transmitted to the overall tool within which the nozzle is integrated.

The above vibrations appear critical especially when the tool is directly handled by a human operator, as in the case of washing lances. Indeed, the vibrations determine a condition of discomfort and disturbance, contributing to reduce the use comfort of the washing system, in addition to producing, in critical cases, documented pathological effects on the operator.

Moreover, the vibrations contribute to increase the noise of the washing system, once again to the detriment of the comfort of the operator and of those around him.

To solve the above drawback, damping systems applied to the washing tool have been used so far; however, these systems significantly contribute to the structural complexity and production costs of the washing machines.

A second drawback relates to the rotation speed of the nozzle body driven by the washing liquid.

In the nozzle assemblies of the described type, the thrust given by the washing liquid must be such as to overcome the inertia of the rotating elements and to keep them in rotation.

Generally, the design of the devices is such as to facilitate the driving process: in fact, it is necessary to ensure a correct starting of the device also for those applications with relatively low working pressures—for example: car washing.

As the pressure values increase, there is a progressive increase in the thrust supplied to the rotating elements, which rotate at a relatively high speed. However, in addition to a certain rotation speed threshold, there is a nebulizing effect of the jet, which results in a substantial reduction in the force with which the jet itself impacts on the surface to be washed and a worsening of the cleaning efficiency of the device.

The technical problem underlying the present invention is to conceive a nozzle assembly having structural and functional features such as to overcome the above drawbacks with respect to the prior art and in particular such as to minimize the vibrations produced, thus improving the user's comfort.

A further object of the present invention is to maximize the power of the liquid jet delivered by the nozzle assembly for any pressure of use.

### SUMMARY OF THE INVENTION

The previously identified technical problem is solved by a rotary jet nozzle assembly for pressure cleaning devices, comprising:
a housing extended along a first longitudinal axis between an inlet and an outlet of a washing liquid, defining therein a containment chamber of the washing liquid in fluid communication with the inlet;
a rotating support within the containment chamber and about the first longitudinal axis due to the effect of the washing liquid coming from the inlet;
a nozzle body extended along a second longitudinal axis inclined with respect to the first longitudinal axis and traversed by a delivery duct, the delivery duct opening upstream on the containment chamber and opening downstream in a delivery opening arranged, in use, at the outlet of the housing, the nozzle body being associated with the support and driven in rotation thereby;
a counterweight, integral with the support and arranged in a position which is eccentric and opposite the nozzle body with respect to the first longitudinal axis, to balance the nozzle body during the rotation of the support about the first longitudinal axis.

As a skilled person may well understand, contrary to the known rotary nozzle assemblies, the presence of a counterweight eccentrically opposite the nozzle body allows dynamically balancing the overall rotor, where rotor stands for the group of rotating elements comprising support, counterweight and nozzle body. In this way it is possible to zero, or at least to reduce, the vibrations of the device during use, said vibrations being mainly due, in the prior art, to the eccentric imbalance of the rotating mass with respect to the rotation axis.

The above nozzle assembly may advantageously provide a composite structure of the support/counterweight unit. Thus, the counterweight may be made of a different material—preferably: of a material with a higher specific weight—with respect to the support.

Thanks to the above expedient, on the one hand it is possible to balance the nozzle body without unduly increasing the rotor moment of inertia, on the other hand the design choices of the materials respectively constituting support and counterweight are kept independent.

Thus, the support may be made of a polymeric material, namely a polymer matrix reinforced material, preferably characterized by a limited mass and a low friction coefficient.

The material may be, for instance, a technical plastic.

On the contrary, the counterweight may be made of a metallic material, preferably brass, which can be the same material as the one which the nozzle body is at least partially made of.

Thanks to the above suggested choice of materials, it is possible to obtain support and counterweight with dedicated production techniques which are different from each other.

Thus, the support may be advantageously obtained by molding the above polymeric or polymeric matrix material, whereas the counterweight may be advantageously obtained from a raw piece by means of machining, for example turning.

In this way, the support is reproducible in large series and at limited cost, thanks to the use of a same mold; on the contrary, the counterweight may be processed on a case-by-case basis depending on specific balancing needs.

The dedicated processing of the counterweight thus allows obtaining an accurate balancing of each single device, easily adapting the mass of the element even in case of deviations or design changes.

Advantageously, the support may comprise a coupling seat adapted to receive the counterweight, the counterweight comprising at least one coupling portion shaped so as to be wedged in, preferably but not necessarily by interference, within the coupling seat of the support.

The coupling by interference allows an integral and reliable assembly of the counterweight on the rotor body, even without resorting to the alternative but economically costly co-molding technique. The use of the co-molding also implies constraints on the choice of the plastic material, since it does not allow using any technical plastic.

The counterweight preferably comprises at least one balancing portion integral with the coupling portion, the balancing portion having different cross section, preferably less than the cross section of the coupling portion, the balancing portion being shaped so as to balance the mass of said nozzle body.

In other terms, the counterweight has a coupling portion rigidly defined to be inserted into the coupling seat of the support and a balancing portion which will instead be reconfigurable according to the specific balancing needs, i.e. it may be adapted to the actual eccentric mass to be balanced.

The balancing portion preferably takes on an at least partially cylindrical shape, i.e. provided with a crown arc-like cross section, so as to conform to the circular shape of the support which it is mounted to.

The coupling portion is preferably a foot having a constant cross section defined by a circular segment.

The counterweight is therefore preferably shaped as a cylinder portion, with a balancing portion that is indented with respect to the coupling portion. The counterweight may of course take on various other shapes, for instance it may be shaped like a metal sphere partially or totally embedded in a designated seat of the support.

The nozzle body has a downstream end, at which the delivery opening opens, and an upstream end, which is constrained to the support by simply lying thereon.

Therefore, the support preferably comprises a seat for the nozzle body, preferably a U-shaped indent, arranged in a position that is eccentric and opposite the coupling seat with respect to the first longitudinal axis of the housing; the upstream end of the nozzle body is introduced within the nozzle body seat.

The nozzle assembly may advantageously comprise at least one elastic element acting on the support adapted to keep, in use, the end downstream of the nozzle body in abutment against a sliding seat arranged at the housing outlet.

Said elastic element may be constituted by a disc spring interposed between said support and a wall upstream of the containment chamber, opposite the housing outlet. Alternatively, the elastic element may be constituted by another elastically deformable member, preferably always interposed between support and wall.

Advantageously, the support may comprise a turbine, configured in such a way as to be hit and driven in rotation by at least part of the washing liquid coming from the housing inlet.

This turbine, provided with a blading hit by at least one portion of the washing liquid, may advantageously be made integral with the rest of the support, preferably by means of a single molding operation.

It should be noted that the turbine greatly facilitates driving the support by the washing liquid; however, it is not strictly necessary, and it is possible to provide for the driving action to develop on other eccentric elements hit by the liquid—for instance on the same nozzle body and/or on the counterweight.

The housing may comprise therein at least one main passage and at least one by-pass passage which connect the inlet to the containment chamber, the at least one main passage and the at least one by-pass passage opening to distinct areas of the containment chamber, the sole washing liquid passing through the main passage hitting the turbine and driving it in rotation.

Thanks to the above described expedient, the nozzle assembly may operate at relatively high pressures and flow rates without the rotor reaching critical rotation speeds due to the adverse nebulization phenomenon. Indeed, the part of washing liquid passing through the by-pass, though participating in the overall capacity of the device, does not contribute to the thrust of the turbine, and on the contrary can slow it down by defining turbulences outside the blading.

It is therefore possible to size the main and by-pass passages in such a way that the flow rate directed to the support is the minimum necessary to drive and keep the nozzle body in rotation, thus limiting the rotation speed as much as possible and therefore the consequent nebulization phenomenon.

It is noted that the provision of main and by-pass passages according to the above stated produces an advantageous effect regardless of the use of a counterweight in the rotary nozzle assembly. Therefore, the proprietor reserves the right to request a divisional patent application relating to a rotary jet nozzle for pressure cleaning devices, comprising:
a housing extended along a first longitudinal axis between an inlet and an outlet of a washing liquid, defining therein a containment chamber of the washing liquid in fluid communication with the inlet;
a support rotating within the containment chamber and about the first longitudinal axis due to the effect of the washing liquid coming from the inlet;
a nozzle body extended along a second longitudinal axis inclined with respect to the first longitudinal axis and traversed by a delivery duct, the delivery duct opening upstream on the containment chamber and opening downstream in a delivery opening arranged, in use, at the housing outlet, the nozzle body being associated with the support and driven in rotation thereby;
where said support comprises a turbine hit and driven in rotation by at least part of the washing liquid coming from the inlet of said housing; and
wherein said housing comprises therein at least one main passage and at least one by-pass passage which connect said inlet to the containment chamber, wherein said at least one main passage and said at least one by-pass passage open to distinct areas of the containment chamber, the sole washing liquid passing through said main passage hitting the turbine and driving it in rotation.

The support, comprising the turbine, is preferably rotatably mounted on a pin integral with the housing which extends along the first longitudinal axis, the turbine comprising a blading surrounding the pin; the at least one main passage then opens to a first area interposed between the pin and the blading, the at least one by-pass passage instead opens to a second area arranged between the blading and a side wall of the housing.

The at least one main passage may traverse the above pin, in a direction at least partially radial with respect thereto.

The pin may extend from a support base integral to the housing, which defines a wall upstream of the containment chamber; an annular interspace, which at least one by-pass passage opens to, is formed between the support base and the side wall.

Further features and advantages will become more apparent from the following detailed description of a preferred, but not exclusive, embodiment of the present invention, with reference to the enclosed figures given by way of example and not for limiting purposes.

### BRIEF DESCRIPTION OF THE DRAWINGS

FIG. 1 shows a longitudinal section view of a first embodiment of a rotary jet nozzle assembly according to the present invention;

FIG. 2 shows a perspective view of a rotor of the nozzle assembly of FIG. 1;

FIG. 3 shows a longitudinal section view of the rotor of FIG. 2;

FIG. 4 shows a perspective view of a support/counterweight unit of the nozzle assembly of FIG. 1;

FIG. 5 shows a further perspective view of a support/counterweight unit of the nozzle assembly of FIG. 1;

FIG. 6 shows a longitudinal section view of the unit of FIG. 5;

FIG. 7 shows a perspective view of a rotor in a second embodiment of the invention;

FIG. 8 shows a longitudinal section view of the rotor of FIG. 7;

FIG. 9 shows a perspective view of a rotor in a third embodiment of the invention;

FIG. 10 shows a longitudinal section view of the rotor of FIG. 9.

### DETAILED DESCRIPTION

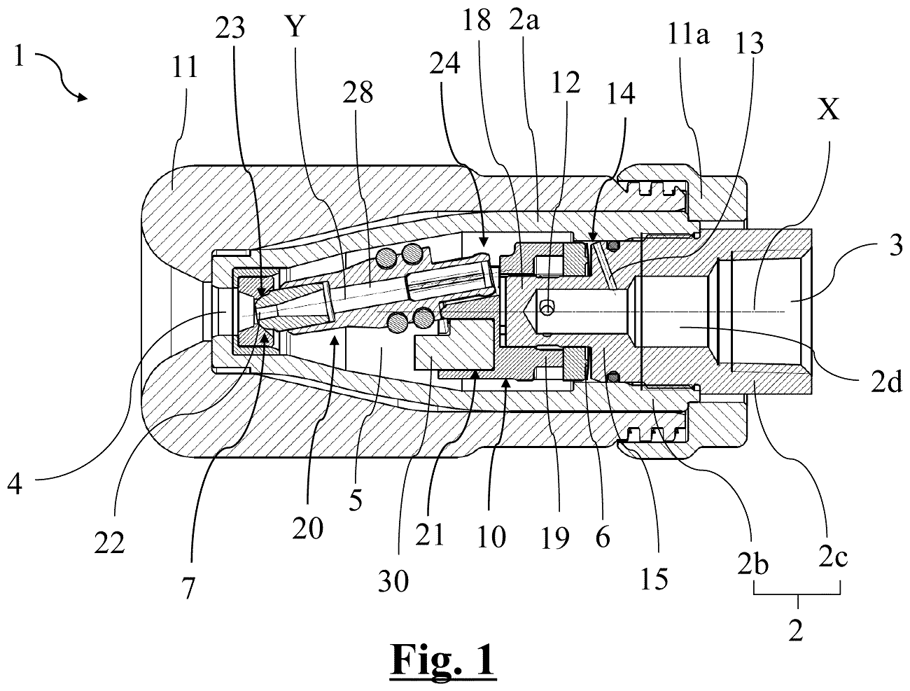

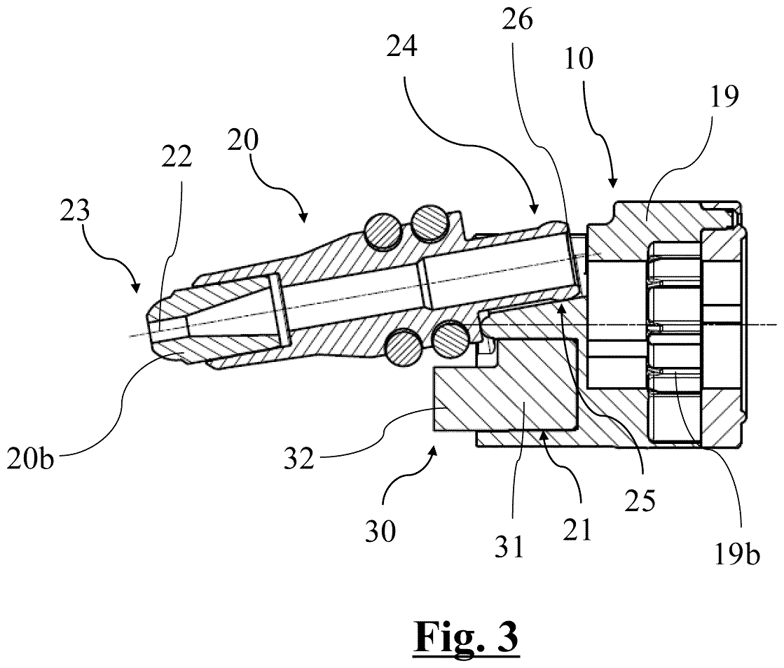

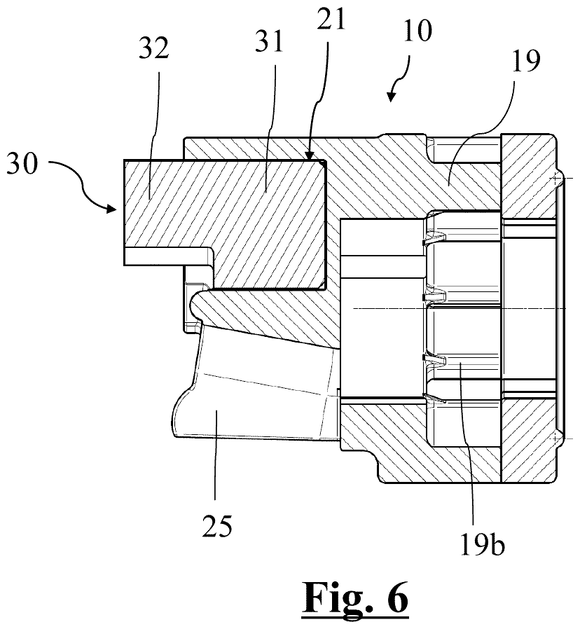

Referring to the enclosed FIGS. 1-6, reference number 1 generically identify a first embodiment of the nozzle assembly according to the present invention.

The nozzle assembly 1 is arranged to generate a rotary liquid jet, preferably but not exclusively in pressure washing applications. The assembly can thus be applied in pressure washing machines, in particular high-pressure washing machines, namely with working pressures comprised between 25 and 1000 bar, such as for instance the pressure washers.

Hereinafter we will refer, without any limiting purpose, to the latter application wherein the nozzle assembly 1 is mounted at the end of a lance that can be gripped by the user in order to deliver a conical jet of washing liquid, usually water, in the direction of a surface to be washed.

The nozzle assembly 1 comprises a housing 2 which extends along a first longitudinal axis X and defines a containment chamber 5 therein.

The housing 2 is in particular defined by two pieces assembled to each other: a housing body 2b and an inlet fitting 2c.

The housing body 2b has a side wall 2a which delimits the containment chamber 5. Said housing body 2b has a substantially tubular shape which tapers towards a downstream end, where the outlet 4, from which the washing liquid is delivered, is defined.

The tubular housing body 2b has, opposite the outlet 4, an opening within which the inlet fitting 2c is screwed, which is thus arranged to close the upstream housing 2.

A sealing gasket is provided between housing body 2b and inlet fitting 2c to ensure the water impermeability of the housing 2.

The fitting 2c has an internal cavity 2d which, besides defining the inlet 3 for the washing liquid, is arranged in fluid communication with the containment chamber 5, as it will be hereinafter discussed in detail.

The fitting 2c is arranged at said inlet 3 for coupling with a washing tool, for instance a pressure washer lance which can be gripped by an operator.

The housing 2 is in turn inserted within a protective casing 11 and kept inserted therein by interposing a ring nut 11a at the inlet 3. Both the protective casing 11 and the ring nut 11a have a protective function of the content.

The fitting 2c has a support base 15 which is arranged laterally in contact with the side wall 2a of the housing body 2b and which delimits upstream the containment chamber 5.

The support base 15 defines, inside the containment chamber 5, a shoulder from which a pin 18 extends, coaxially to the first longitudinal axis X.

The support base 15 has, peripherally to the above shoulder, a chamfer defining an interspace 14 between the support base 15 itself and the side wall 2a of the housing body 2b.

The nozzle assembly 1 moreover comprises, inside the containment chamber 5, a rotor comprising a support 10, a counterweight 30 and a nozzle body 20.

The support 10 is rotatably mounted above the pin 18, and is therefore arranged to rotate about the first longitudinal axis X. The nozzle body 20 and the counterweight 30 are integrally supported by said support 10 and driven in rotation together with it.

The nozzle body 20 extends along a second longitudinal axis Y between an upstream end 24 thereof, constrained to the support 10 by simply lying thereon, and a downstream end 23 thereof which abuts against a sliding seat 7 arranged at the outlet 4 of the housing 2.

Both the sliding seat 7 and a corresponding nozzle tip 20b are made of low friction coefficient material, for instance ceramic or tungsten carbide.

The entire support 10 is pushed in the direction of the outlet 4 of the housing 2 by an elastic element 6, in this case a disc spring, arranged between the shoulder of the support base 15 and a bottom surface of the support 10. The action of the disc spring keeps the nozzle tip 20b in constant contact against the sliding seat 7 thereof, thus avoiding shocks that could result in the breakage of these relatively fragile elements.

The support 10 comprises in turn a turbine 19, equipped with a blading 19b which coaxially surrounds the pin 18. As it will be clearer hereinafter, the turbine 19 is arranged to be hit by a flow of washing liquid which drives in rotation the entire rotor.

The above nozzle body 20, extended along a second longitudinal axis Y inclined with respect to the first longitudinal axis X of the housing 2, is therefore driven in rotation keeping in contact with the sliding seat 7 by tracing a revolution cone which is coaxial to the first longitudinal axis X.

The nozzle body 20 is traversed by a delivery duct 28 which extends axially between an access opening 26 at the upstream end 24 and a delivery opening 22 at the downstream end 23, placed in fluid communication with the outlet 4 of the housing 2.

The washing liquid entering from the inlet 3 after having passed through the inlet cavity 2d, is divided into two alternative passages, a main passage 12 and a by-pass passage 13, both of which open to the containment chamber 5.

The main passage 12 radially traverses the pin 18 and opens to the containment chamber 5 close to the pin 18 itself surrounded by the blading 19b of the turbine 19. The portion of liquid which passes through said passage is thus directed towards the blading 19b, driving it in rotation in its movement towards the side wall 2a.

From here, the liquid continues into the containment chamber 5, then it enters the nozzle body 20 from which it exits at the outlet 4.

Instead, the by-pass passage 13 branches off from a portion of the inlet cavity 2d upstream with respect to the pin 18, and opens at the above chamfer, namely to a peripheral annular interspace 14 upstream of the turbine 19.

The washing liquid which passes through the by-pass passage 13 continues directly towards the nozzle body 20 and from here to the outlet 4, without passing through the blading 19b of the turbine 19.

As a skilled person may well understand, in this way, by suitably sizing the main passage 12 and the by-pass passage 13 (preferably in a flow ratio of 3 to 1), it is possible to limit the steady rotation speed of the nozzle body 20 even at high flow rates and pressures, thus reducing the nebulization phenomenon which affects the impact force of the jet in the embodiments according to the prior art.

Indeed, the liquid passing through the by-pass passage 13, though defining the overall output flow rate, does not contribute to the rotation speed of the turbine 19. The meeting of this liquid with that coming from the main passage 12 produces a turbulence at the blading 19b, which tends to slow down the turbine 19.

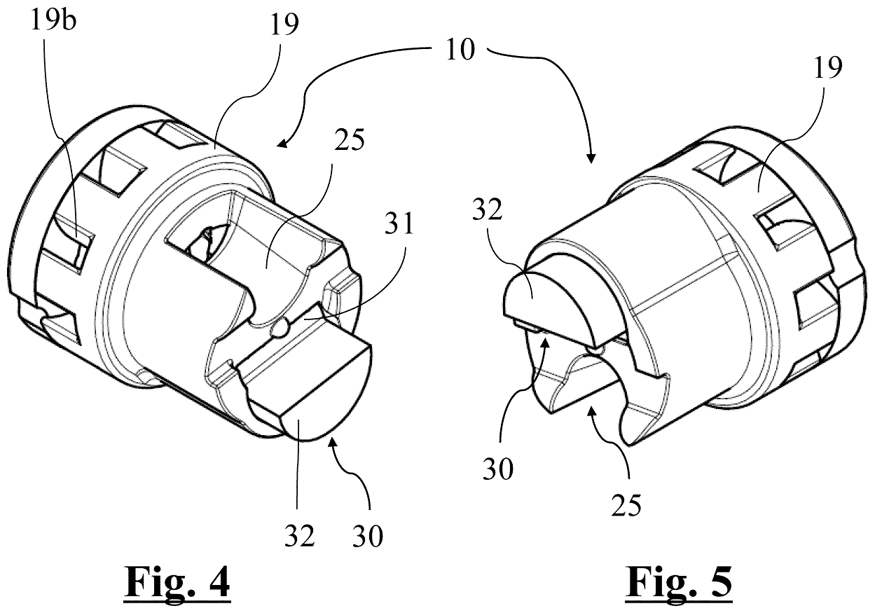

As it can be better seen from FIGS. 4 and 5, the support 10 has, downstream of the turbine 19, a nozzle body seat 25, which is U-shaped for receiving the upstream end 24 of a nozzle body 20, in an eccentric position with respect to the first longitudinal axis X.

The support 10 also has a coupling seat 21 arranged to receive a counterweight 30. Said coupling seat 21 is arranged in a position opposite the nozzle body seat 25 with respect to the first longitudinal axis X.

The above introduced counterweight 30 has the purpose of dynamically balancing the eccentric mass of the nozzle body 20 during its rotation, namely it is sized to reduce the resulting moment of the rotor with respect to the first longitudinal axis X as much as possible—ideally to zero.

In the first embodiment, the counterweight 30 is inserted with interference fit within the coupling seat 21.

Moreover, the support 10 is made of polymeric or polymer matrix material so as to minimize wear during the rotation about the metal pin 18. The choice of the material is also such as to make the support 10 by molding from a specifically shaped mold.

In this way, once the mold has been defined and produced, it is possible to easily reproduce by molding the support 10 to be used in each nozzle assembly 1.

In the first embodiment, the support 10 is made of a technical plastic suitable for the application.

The counterweight 30 is instead made of a material different from the support 10 and having a higher specific weight. Said material is preferably a metallic material and in the embodiment herein described brass is used.

The use of a metallic material, such as brass, allows obtaining the counterweight 30 by machining, for instance by turning, starting from a unique piece, for instance a bar. In this way, by varying the processing performed to make the piece, it is possible to obtain a counterweight having a desired shape and mass.

Generally, the nozzle assemblies as the one described must work at different flow rates using nozzles of different sizes and masses. The use of a metallic material, easily processable and customizable, thus allows realizing different counterweights to be used under the various use conditions to adequately balance the mass of the nozzle body during the rotation.

In the first embodiment, the counterweight 30 is made of two contiguous portions: a coupling portion 31 shaped so as to be inserted with interference fit within the coupling seat 21 of the support 10 and a balancing portion 32 specifically shaped so as to have mass, shape and sizes such as to counter-balance the nozzle body 20 during the rotation.

In particular, in the first embodiment the counterweight 30 has a coupling portion 31 having a cross section corresponding to the cross section of the coupling seat 21 thus realizing a fixed constraint. The balancing portion 32 has instead a cross section less than the coupling portion 31 made by machining.

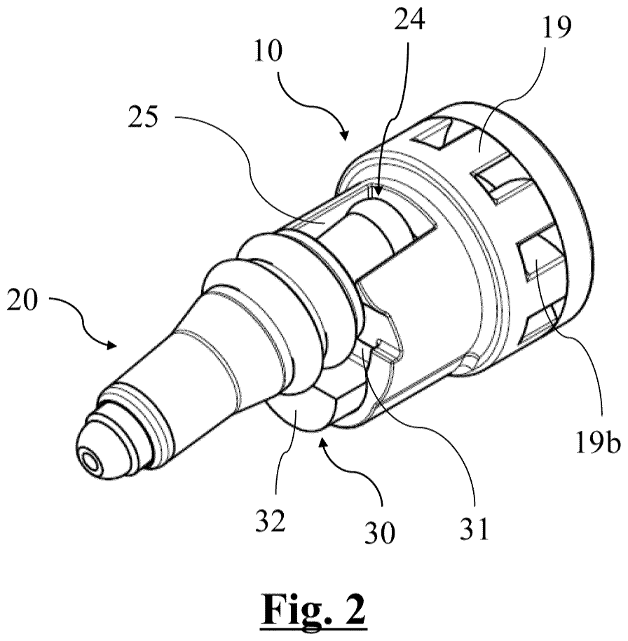

As it may be noticed from FIGS. 2 and 4, the balancing portion has a particular semi-cylindrical shape, whose longitudinal axis is parallel to the first longitudinal axis X of the housing 2 when the counterweight 30 is inserted in the coupling seat 21.

The counterweight 30 thus formed may be replaced by another counterweight having a same coupling portion, or at least that may be wedged in the coupling seat 21, and a different balancing portion.

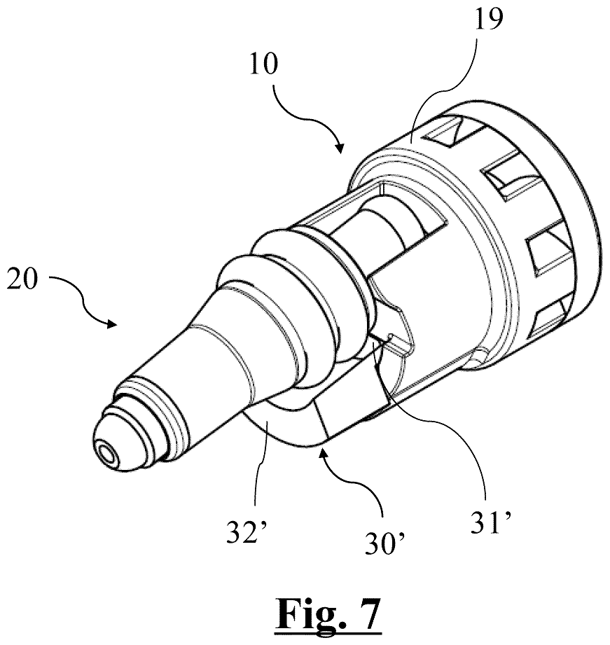

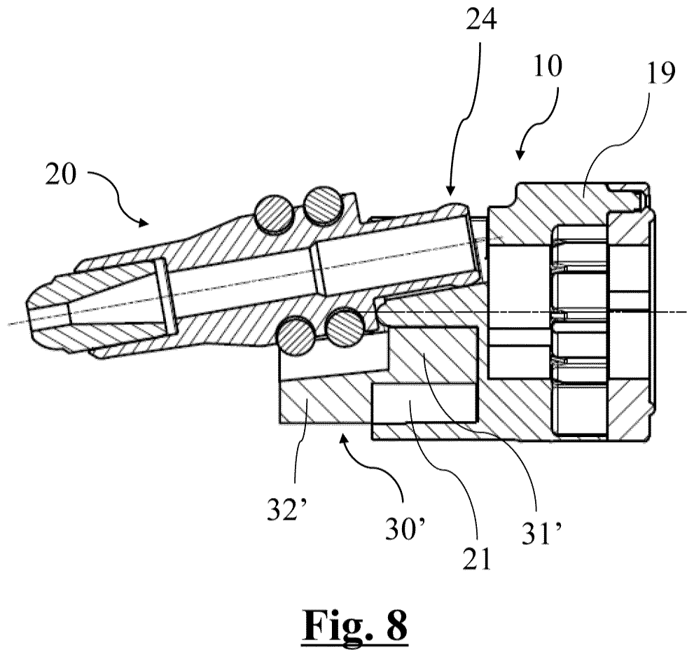

In a second embodiment, a nozzle assembly otherwise identical to the one described above adopts a different rotor, illustrated in FIGS. 7-8.

In this embodiment, the counterweight 30′ has a coupling portion 31′ insertable into the coupling seat 21 and a balancing portion 32′ having a different shape, in particular with a crown-arch cross section.

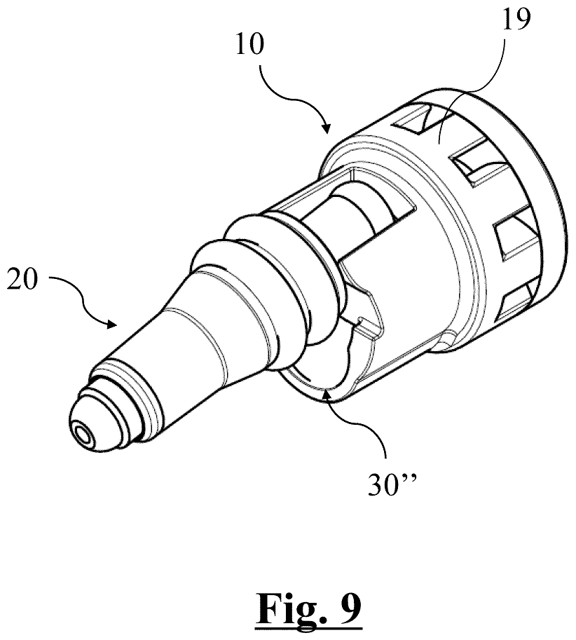

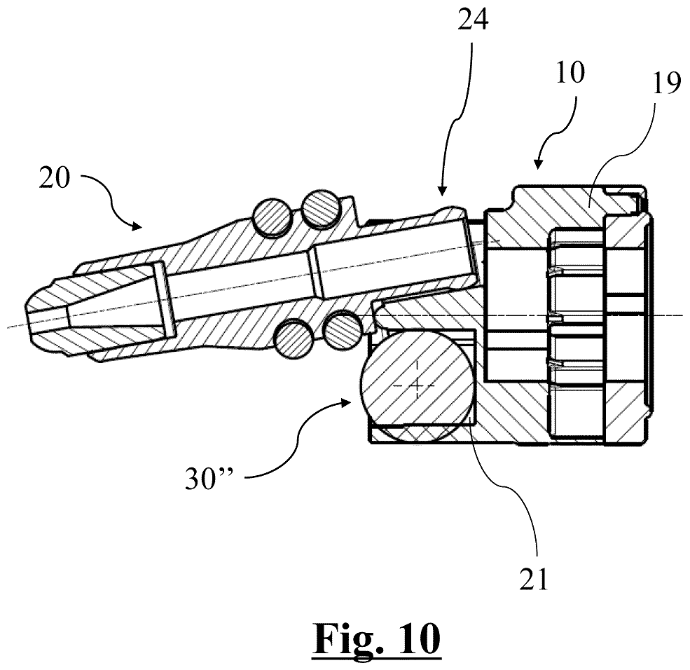

In a third embodiment, a nozzle assembly otherwise identical to the one described above adopts a different rotor, illustrated in FIGS. 9-10.

In this case the counterweight 30″ has a spherical shape embedded within the coupling seat 21 of the support 10.

Obviously, a skilled person can make several changes and variants to the above described invention, in order to meet contingent and specific needs, all of them by the way contained in the scope of protection of the invention as defined by the following claims.

1. A rotary jet nozzle assembly for pressure cleaning devices, comprising:
a housing extended along a first longitudinal axis between an inlet and an outlet of a washing liquid, defining therein a containment chamber of the washing liquid in fluid communication with said inlet;
a support fully rotatable about said first longitudinal axis within said containment chamber, due to the effect of the washing liquid coming from said inlet;
a nozzle body extended along a second longitudinal axis inclined with respect to the first longitudinal axis and traversed by a delivery duct, said delivery duct opening upstream on the containment chamber and opening downstream in a delivery opening arranged, in use, at said outlet of the housing, said nozzle body being associated with said support and driven in rotation thereby;
a counterweight, integral with said support and arranged in a position that is eccentric and opposite the nozzle body with respect to the first longitudinal axis, to balance said nozzle body during the rotation of the support about the first longitudinal axis;
wherein said counterweight is made of a first material and said support is made of a second material, said first material being different from said second material.

2. The nozzle assembly according to claim 1, wherein said first material has a higher specific weight than said second material.

3. The nozzle assembly according to claim 2, wherein said first material is a metallic material, the second material being a polymeric material or a polymer matrix material.

4. The nozzle assembly according to claim 3, wherein said support is made by molding and said counterweight is made by machining.

5. The nozzle assembly according to claim 1, wherein said support comprises a coupling seat adapted to receive said counterweight, said counterweight comprising at least one coupling portion shaped so as to be wedged in the coupling seat of said support.

6. The nozzle assembly according to claim 5, wherein said counterweight further comprises at least one balancing portion integral with said coupling portion, said balancing portion having a different cross section, the balancing portion being shaped so as to dynamically balance the mass of said nozzle body.

7. The nozzle assembly according to claim 4, wherein said nozzle body comprises a downstream end at which said delivery opening opens and an upstream end associated with said support; said support comprising a nozzle body seat arranged in a position eccentric and opposite said coupling seat with respect to the first longitudinal axis of said housing; the upstream end of said nozzle body being introduced within said seat for nozzle body.

8. The nozzle assembly according to claim 1, wherein said nozzle body comprises a downstream end at which said delivery opening opens and an upstream end associated with said support; said nozzle assembly further comprising at least one elastic element acting on said support adapted to keep, in use, said downstream end of said nozzle body in abutment against a sliding seat arranged at said outlet.

9. The nozzle assembly according to claim 1, wherein said support comprises a turbine hit and driven in rotation by at least a part of the washing liquid coming from the inlet of said housing.

10. The nozzle assembly according to claim 9, wherein said housing comprises therein at least one main passage and at least one by-pass passage which connect said inlet to the containment chamber, wherein said at least one main passage and said at least one by-pass passage open to distinct areas of the containment chamber, the sole washing liquid passing through said main passage hitting the turbine and driving it in rotation.

11. The nozzle assembly according to claim 10, wherein said support is rotatably mounted on a pin integral to the housing which extends along said first longitudinal axis, said turbine comprising a blading which surrounds said pin; said at least one main passage opening to a first area interposed between said pin and said blading, said at least one by-pass passage opening to a second area arranged between said blading and a side wall of said housing.

12. The nozzle assembly according to claim 11, wherein said at least one main passage traverses said pin.

13. The nozzle assembly according to claim 12, wherein said pin extends from a support base integral with said housing; an interspace being formed inside said containment chamber between said support base and said side wall said at least one by-pass passage opening to said interspace.

14. The nozzle assembly according to claim 3, wherein the metallic material is brass.

15. The nozzle assembly according to claim 6, wherein the different cross section of said balancing portion is less than the cross section of said coupling portion.
